(19) United States
(12) Patent Application Publication
(10) Pub. No.: US 2009/0171063 A1
(43) Pub. Date: Jul. 2, 2009

(54) Polyimide film and methods relating thereto

(76) Inventors: Tadashi Ishibashi, Aichi (JP); Hirokazu Yokoyama, Aichi (JP); Shinsuke Yamashita, Aichi (JP); Shotaro Hidaka, Aichi (JP); Hitomi Murase, Toyoake-shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/012,102

(22) Filed: Jan. 31, 2008

Related U.S. Application Data
(60) Provisional application No. 61/015,885, filed on Dec. 21, 2007.

(51) Int. Cl. C08G 69/26

(52) U.S. Cl. 528/353

(57) ABSTRACT

A polyimide film with advantageous handleability, flexibility, dimensional stability and heat resistance is provided. The polyimide film is characterized by block-copolymerizing an aromatic diamine component comprising 10˜25 mol % of paraphenylenediamine (a1) and 75˜90 mol % of 4,4′-diaminodiphenyl ether (a2) with an aromatic tetracarboxylic acid component consisting of 75˜99.9 mol % of pyromellitic acid dianhydride (b1) and 0.1˜25 mol % of 3,3′,4,4′-biphenyl tetracarboxylic acid dianhydride (b2). The Young's modulus, linear expansion coefficient, water absorption rate and glass transition temperature of such polyimide films can be controlled within very useful ranges.

### FIELD OF THE INVENTION

The present invention relates generally to polyimide films having excellent handleability, flexibility, dimensional stability and heat resistance. More specifically, the polyimide films of the present invention comprise a block co-polymer polyimide derived from paraphenylenediamine, 4,4′-diaminodiphenyl ether, pyromellitic acid dianhydride and 3,3′,4,4′-biphenyl tetracarboxylic acid dianhydride.

### BACKGROUND OF THE INVENTION

Polyimide films have been widely utilized for applications such as base films obtained by laminating with metal foil, for instance, copper foil, via an adhesive for flexible circuit substrates due to its excellent insulation property and heat resistance. A balance between handleability and flexibility is generally required of polyimide films. Also, dimensional stability can also be important, as well as water absorption rate and a linear expansion coefficient. See generally, Japanese patent publications: i. Kokai Patent Sho 60[1985]-210629; and ii. Kokai Patent Hei 9[1997]-286858.

However, conventionally known polyimide film consisting of 4,4′-diaminodiphenyl ether and pyromellitic acid dianhydride can be problematic when attempting to obtain a polymer having an appropriate balance of modulus, temperature stability, water absorption and linear expansion. A need also exists for large scale, commercially practical methods of producing such polyimide films that do not require large amounts of reagents, time and labor.

### SUMMARY OF THE INVENTION

The present disclosure is directed to a polyimide film containing a block copolymer. The block copolymer contains an aromatic diamine component and an aromatic tetracarboxylic acid component. The aromatic diamine component is derived from: i. 10-25 mol % paraphenylenediamine; and ii. 75-90 mol % 4,4′-diaminodiphenyl ether. The aromatic tetracarboxylic acid component is derived from: i. 75-99.9 mol % pyromellitic acid dianhydride; and ii. 0.1-25 mol % of 3,3′,4,4′-biphenyl tetracarboxylic acid dianhydride.

### DETAILED DESCRIPTION OF THE PREFERRED EMBODIMENT(S)

One embodiment of the present disclosure is obtained by block copolymerizing an aromatic diamine component with an aromatic tetracarboxylic acid component. In such an embodiment, the diamine component comprises: i. paraphenylenediamine in a range between (and optionally including) any two of the following: 10, 12, 15, 16, 17, 18, 19, 20, 21, 22, 23, 24, and 25 mol % of total diamine used in the copolymer; and ii. 4,4′-diaminodiphenyl ether in a range between (and optionally including) any two of the following: 75, 77, 79, 80, 82, 84, 85, 87, 88, 89, and 90 mol % of total diamine used in the copolymer. The aromatic tetracarboxylic acid component in this embodiment comprises: i. pyromellitic acid dianhydride in a range between (and optionally including) any two of the following: 75, 77, 80, 82, 85, 87, 90, 92, 94, 95, 98, 99. 99.5 and 99.9 mol % of total tetracarboxylic acid component; and ii. 3,3′,4,4′-biphenyl tetracarboxylic acid dianhydride in a range between (and optionally including) any two of the following: 0.1, 0.2, 0.5, 0.7, 0.9, 1, 2, 3, 5, 7, 9, 10, 12, 14, 15, 18, 20, 21, 22, 23, 24 and 25 mol % of total tetracarboxylic acid component

In one embodiment, the polyimide film of the present disclosure has a Young's modulus of 4 GPa to 5 GPa, a linear expansion coefficient of 12 ppm/° C. to 20 ppm/° C.; a water absorption rate of 2.6% by weight or less; and a glass transition temperature of 350° C. or higher.

Further, the polyimide films of the present invention can be produced efficiently by any one of the following methods:
1. a method of: (i.) block co-polymerizing by reacting an excess of paraphenylenediamine (“PPD”) with a deficit amount of pyromellitic acid dianhydride (“PMDA”), then adding 4,4′-diaminodiphenyl ether (“DADE”) and 3,3′,4,4′-biphenyl tetracarboxylic acid dianhydride (“BPTA”), and then adding the remaining pyromellitic acid dianhydride (“PMDA”) in an amount sufficient to provide a molar amount that is substantially the molar equivalent of the PPD; and (ii.) forming the resulting polyamic acid into a film, and thermally and/or chemically imidizing.
2. a method of: (i.) block co-polymerizing by reacting an excess of paraphenylenediamine (“PPD”) with a deficit amount of pyromellitic acid dianhydride (“PMDA”), then adding 4,4′-diaminodiphenyl ether (“DADE”) and the remaining pyromellitic acid dianhydride (“PMDA”), and then adding 3,3′,4,4′-biphenyl tetracarboxylic acid dianhydride (“BPTA”), and (ii.) forming the resulting polyamic acid into a film, and thermally and/or chemically imidizing.
3. a method of: (.i) block co-polymerizing 4,4′-diaminodiphenyl ether (“DADE”) with a deficit amount of pyromellitic acid dianhydride (“PMDA”), and successively adding paraphenylenediamine (“PPD”) and the remaining pyromellitic acid dianhydride (“PMDA”) and 3,3′,4,4′-biphenyl tetracarboxylic acid dianhydride (“BPTA”); and (ii.) forming the resulting polyamic acid into a film, then thermally and/or chemically imidizing it.
4. a method of: (i.) block co-polymerizing 4,4′-diaminodiphenyl ether (“DADE”) with a deficit amount of pyromellitic acid dianhydride (“PMDA”), then successively adding paraphenylenediamine (“PPD”), 3,3′,4,4′-biphenyl tetracarboxylic acid dianhydride (“BPTA”) and the remaining pyromellitic acid dianhydride (“PMDA”), and (ii) forming the resulting polyamic acid into a film, and thermally and/or chemically imidizing.

The above methods of the present invention can provide polyimide films having a Young's modulus of 4 GPa to 5 GPa, a linear expansion coefficient of 12 ppm/° C. to 20 ppm/° C., a glass transition temperature of 350° C. or higher and a water absorption rate of 2.6% by weight or less. Such polyimide films provide useful handleability, flexibility, dimensional stability and heat resistance.

According to the present invention, a high-quality polyimide film can be mass-produced efficiently at low cost without requiring many reagents, time, labor, and the like in a treatment for enhancing the Young's modulus, handleability, flexibility, dimensional stability and heat resistance of the polyimide film.

First, an explanation on the definition of physical properties in the present invention is given.

Namely, Young's modulus of the present invention is determined from the slope of the initial rising section in a tension-strain curve obtained at room temperature and tensile velocity of 100 mm/min by a Tensilon type tensile tester, manufactured by Orienrec [sic; Orientec] Co., Ltd., in accordance with JIS K7113.

Young's modulus of the polyimide film of the present invention is desirably 4 GPa to 5 GPa, more preferably 4.0 GPa to 4.5 GPa. When it is less than 4 GPa, the handleability tends to be damaged. When it exceeds 5 GPa, the flexibility tends to be damaged.

The linear expansion coefficient in the present invention is measured in the temperature range of 50° C. to 200° C. under the condition of a rate of temperature increase of 10° C./min by mechanocaloric analyzer TMA-50, manufactured by Shimadzu Co., Ltd.

The linear expansion coefficient of the polyimide film of the present invention is desirably 12 ppm/° C. to 20 ppm/° C., more preferably 12 ppm/° C. to 19 ppm/° C. When it is not in this range, the dimensional stability tends to be damaged due to the difference in linear expansion coefficient with copper foil. The linear expansion coefficient can be further lowered by drawing the polyamic acid or polyimide film if necessary. The drawing ratio [rate] is preferably 1.052.00 times.

The water absorption rate in the present invention is determined from the loss in weight in the temperature range of 50˜200° C. under heating by weight loss analysis when the polyimide film is immersed in distilled water for 48 hours and is heated from room temperature to 200° C. at a rate of temperature increase of 10° C./min after the water on the surface is wiped off.

The water absorption rate of the polyimide film of the present invention is desirably 2.6% by weight or less, more preferably 2.3% by weight or less. If it exceeds 2.6% by weight, the dimensional stability tends to be damaged by water absorption. The smaller the water absorption rate the better, but its lower limit is up to 1% by weight in terms of the chemical composition.

The glass transition temperature in the present invention is determined from the peak elastic modulus loss measured under a temperature range of from room temperature to 500° C., rate of temperature increase of 2° C./min, and frequency of 10 Hz by EXSTER 6000, manufactured by Seiko Instrument Co., Ltd.

The glass transition temperature of the polyimide film of the present invention is desirably 350° C. or higher and more desirably 353° C. or higher. When it is lower than 350° C., it tends to cause thermal deformation of the polyimide film by heat during soldering. The higher the glass transition temperature the better, but it is difficult in practice to measure it when the temperature is 400° C. or higher.

In the polyimide film of the present invention, it is ideal that the Young's modulus, linear expansion coefficient, water absorption rate and glass transition temperature are within the above-stated ranges; a polyimide film superior in handleability, flexibility, dimensional stability and heat resistance can be obtained when these four properties are satisfied.

It is an indispensable condition that the aromatic diamine component to be used in the polyimide film of the present invention contains paraphenylenediamine (sometimes abbreviated as a1 or “PPD”) and 4,4′-diaminodiphenyl ether (sometimes abbreviated as b1 or “DADE”). This is because the polyimide film does not exhibit the desired Young's modulus, linear expansion coefficient, water absorption rate and glass transition temperature when it does not contain the aromatic diamine component.

It is important that the addition amount of paraphenylenediamine to be used in polyimide film is regulated within a range of 10˜25 mol %, preferably 15˜20 mol %.

Namely, when the addition amount is less than the aforementioned range, Young's modulus of the polyimide film becomes lower than 4 GPa, and the linear expansion coefficient exceeds 20 ppm/° C. Further, when the addition amount is more than the aforementioned range, Young's modulus becomes higher than 5 GPa; also, the water absorption rate becomes higher than 2.6% by weight, and the linear expansion coefficient becomes smaller than 12 ppm/° C.

It is an indispensable condition that the aromatic tetracarboxylic acid component to be used in polyimide film of the present invention contains pyromellitic acid dianhydride (sometimes abbreviated as b1) and 3,3′,4,4′-biphenyl tetracarboxylic acid dianhydride (sometimes abbreviated as b2).

It is important that the addition amount of 3,3′,4,4′-biphenyl tetracarboxylic acid dianhydride to be used in polyimide film of the present invention is controlled within a range of 0.1˜25 mol %, preferably 1˜10 mol %.

Namely, when the addition amount of 3,3′,4,4′-biphenyl tetracarboxylic acid dianhydride is less than the aforementioned range, the water absorption rate becomes higher than 2.6% by weight; further, when it is more than the aforementioned range, the glass transition temperature becomes lower than 350° C.

Next, an explanation on the constituent components of the polyimide film of the present invention is given.

The polyimide in polyimide film of the present invention is obtained by thermally and/or chemically the imidizing polyamic acid consisting of the aforementioned aromatic tetracarboxylic acid component and aromatic diamine component.

Pyromellitic acid and 3,3′,4,4′-biphenyl tetracarboxylic acid, which form the polyamic acid as a precursor of the polyimide film, may contain another aromatic tetracarboxylic acid within a range that does not hinder the objective of the present invention. As concrete examples, 2,3′,3,4′-biphenyl tetracarboxylic acid, 3,3′,4,4′-benzophenone tetracarboxylic acid, 2,3,6,7-naphthalene carboxylic acid, 2,2-bis(3,4-dicarboxyphenyl) ether, pyridine-2,3,5,6-tetracarboxylic acid and amide-forming derivatives thereof are exemplified. In the production of the polyamic acid, an acid anhydride of these aromatic tetracarboxylic acids may be added in a small amount.

Similarly, paraphenylenediamine and 4,4′-diaminodiphenyl ether, which form the polyamic acid precursor, may contain other aromatic diamines in a range that does not hinder the objective of the present invention. As concrete examples, metaphenylenediamine, benzidine, p-xylenediamine, 3,4′-diaminodiphenyl ether, 4,4′-diaminodiphenylmethane, 4,4′-diaminodiphenylsulfone, 3,3′-dimethyl-4,4′-diaminodiphenylmethane, 1,5-diaminonaphthalene, 3,3′-dimethoxybenzidine, 1,4-bis(3-methyl-5-aminophenyl) benzene and amide-forming derivatives thereof are exemplified. These aromatic diamines may be added in a small amount in the production of the polyamic acid.

Further, as concrete examples of organic solvents to be used in the formation of the polyamic acid as a precursor of the polyimide film in the present invention, one can mention sulfoxide solvents such as dimethyl sulfoxide, diethyl sulfoxide, and the like, polyamide solvents such as N,N-dimethylformamide, N,N-diethylformamide, and the like, polyacetamide solvents such as N,N-dimethylacetamide, N,N-diethylacetamide, and the like, pyrollidone solvents such as N-methyl-2-pyrollidone, N-vinyl-2-pyrollidone, and the like, phenol solvents such as phenol, o-, m-, or p-cresol, xylenol, halogenated phenol, catechol, and the like, and aprotic polar solvents such as hexamethyl phosphoramide, γ-butyrolactone and the like, with it being desired to use these solvents alone or as a mixture. Furthermore, aromatic hydrocarbons such as xylene, toluene, and the like also can be used.

It is preferred to contain the organic solvent solution (polyamic acid solution) of the polyamic acid to be used in the present invention at 5˜40% by weight, more preferably 10˜30% by weight, as solids. Further, its viscosity measured by a Brookfield viscometer is preferably within a range of 10˜2000 Pa·s, more preferably within a range of 100˜1000 Pa·s, for stable feeding. Further, the polyamic acid in the organic solvent solution may be partially imidized.

In the present invention, the aromatic tetracarboxylic acid component and aromatic diamine component for the polyamic acid are polymerized roughly in an equimolar amount, but it is preferred to mix one component in an excess amount of up to 10 mol %, more preferably up to 5 mol %, with respect to the other component.

It is preferred to continuously carry out the polymerization reaction in a temperature range of 0˜80° C. for 10 minutes to 30 hours under stirring and/or mixing, but the polymerization may be carried out by dividing the reactants or the temperature may fluctuate. The addition order of both reactants is not particularly restricted, but it is preferred to add the aromatic tetracarboxylic acid into the aromatic diamine solution. Vacuum defoaming during polymerization reaction is an effective method for preparing a good-quality organic solvent solution of the polyamic acid.

Further, the polymerization reaction may be controlled by adding a small amount of a terminal sealing agent to the aromatic diamine prior to the polymerization reaction.

Next, the production method of the polyimide film is explained.

In the present invention, a polyamic acid solution having a viscosity, measured at 25° C. by a rotary viscometer, of 10 Pa·s to 500 Pa·s is prepared. As the reaction process for obtaining the polyamic acid solution in the present invention, the method of dissolving an aromatic amine in an organic polar solvent and adding an aromatic tetracarboxylic acid dianhydride, or the method of adding an aromatic tetracarboxylic acid dianhydride to an organic polar solvent, then adding an aromatic diamine, can be used. In this time, a practically equimolar amount of anhydride and aromatic diamine can be added to the aromatic tetracarboxylic acid.

Further, blend polymerization, random polymerization and block polymerization are exemplified as polymerization methods of paraphenylenediamine, 4,4′-diaminophenyl ether, pyromellitic acid dianhydride and biphenyl tetracarboxylic acid dianhydride, but block polymerization becomes an indispensable condition for controlling the Young's modulus, linear expansion coefficient, water absorption rate and glass transition temperature in the desired ranges.

Furthermore, as the addition order in block polymerization, the method of successively adding 4,4′-diaminodiphenyl ether, 3,3′,4,4′-biphenyl tetracarboxylic acid dianhydride and the remaining pyromellitic acid dianhydride after reacting paraphenylenediamine with a part of the pyromellitic acid dianhydride; the method of successively adding 4,4′-diaminodiphenyl ether, the remaining pyromellitic acid dianhydride and 3,3′,4,4′-biphenyltetracarboxylic acid dianhydride after reacting paraphenylenediamine with a part of the pyromellitic acid dianhydride; the method of successively adding paraphenylenediamine, the remaining pyromellitic acid dianhydride, and 3,3′,4,4′-biphenyltetracarboxylic acid dianhydride after reacting 4,4′-diaminodiphenyl ether with a part of the pyromellitic acid dianhydride; and the method of successively adding paraphenylenediamine, 3,3′,4,4′-biphenyl tetracarboxylic acid dianhydride and the remaining pyromellitic acid dianhydride after reacting 4,4′-diaminodiphenyl ether with a part of the pyromellitic acid dianhydride are exemplified, but the addition order is not particularly restricted. However, the method of successively adding 4,4′-diaminodiphenyl ether, 3,3′,4,4′-biphenyltetracarboxylic acid dianhydride and pyromellitic acid dianhydride is preferred from the viewpoint of the water absorption rate and Young's modulus of the polyimide film to be obtained. With pyromellitic acid dianhydride, it s preferred to divide it into two parts and add this twice. In this case, it is preferred to first add 50200% [sic] by mole with respect to the previously added paraphenylenediamine or 4,4′-diaminodiphenyl ether, then to add the remaining part. In this way, a block-copolymerized polyamic acid having a small molecular weight distribution is obtained.

It is preferred to obtain a polyimide film from the aforementioned polyamic solution in the following manner. Namely, the polyamic acid solution is cast on a support to obtain a self-supporting polyamic acid film; after fixing the end of the polyamic acid film, it is heated at a temperature of 200° C. to 400° C. to obtain the polyimide film.

Furthermore, the “support” mentioned above means those substances that have a plane [planar structure] like that of glass, metal, plastics film or the like, and can support the polyamic acid when it is cast.

Further, “cast” means that the polyamic acid is spread out on the support. As an example for such a cast, a method of extruding the polyamic acid from a bar coat, spin coat or pipe-form material having arbitrary cavity form, and spread out on the support, is exemplified.

In imidization cleavage, namely the formation of an aromatic polyimide film by cyclization, chemical cleavage method of dehydration by using a dehydrating agent and catalyst, and/or thermal cleavage method of thermally dehydration may be used.

As the dehydrating agent to be used in the chemical cleavage method, an aliphatic acid anhydride such as acetic anhydride and an acid anhydride such as phthalic anhydride are exemplified, and these can be used alone or as a mixture.

Further, alicyclic tertiary amines such as pyridine, picoline, quinoline, and the like, aliphatic tertiary amines such as triethylamine and the like, and tertiary amines such as N,N-dimethylaniline and the like are exemplified as catalysts; these can be used alone or as a mixture.

It is desired that the polyimide film of the present invention have a thickness of 3˜250 μm. Namely, when the thickness is less than 3 μm, it becomes difficult to retain the shape, and when it exceeds 250 μm, it is unfit for use in flexible circuit boards since it lacks bendability.

The polyimide film can be used after drawing or with no drawing. Further, the polyimide film can contain inorganic or organic additives at an amount of up to 10% by weight for improvement of the processability.

The polyimide film of the present invention thus obtained has a Young's modulus of 4 GPa to 5 GPa, thereby superior in handleability and flexibility; linear expansion coefficient of 12 ppm/° C. to 20 ppm/° C. and water absorption rate of 2.6% by weight or less, thereby superior in dimensional stability; and furthermore a glass transition temperature of 350° C. or higher, thereby superior in heat resistance, so it is extremely useful as a base film for flexible circuit boards.

### EXAMPLES

Next, the present invention is explained in further detail by application examples. Furthermore, Young's modulus, linear expansion coefficient, water absorption rate and glass transition temperature in the application examples were measured by the following methods.

### Young's Modulus

Young's modulus is determined from the slope of the initial rising section in a tension-strain curve obtained at room temperature and tensile velocity of 100 mm/min by a Tensilon type tensile tester, manufactured by the Orientec Co., Ltd., in accordance with JIS K7113.

### Linear Expansion Coefficient

Linear expansion coefficient is measured in the temperature range of 50° C. to 200° C. under the condition of a rate of temperature increase of 10° C./min by TMA-50, manufactured by the Shimadzu Co., Ltd.

### Water Absorption Rate

Water absorption rate is determined by the loss in weight in the temperature range of 50˜200° C. by weight loss analysis under heating when the polyimide film is immersed in distilled water for 48 hours, and is heated from room temperature to 200° C. at a rate of temperature increase of 10° C./min after the water on the surface is wiped off.

### Glass Transition Temperature

Glass transition temperature is determined from peak of the elastic modulus loss measured under conditions of a temperature range of room temperature to 500° C., rate of temperature increase of 2° C./min, and frequency of 10 Hz by EXSTER 6000, manufactured by the Seiko Instrument Co., Ltd.

### Application Example 1

Paraphenylenediamine [at] 2.42 g (22.3 mmol) and N,N′-dimethylacetamide 223.81 g were put into a 500-ml separatory flask provided with a DC stirrer, then pyromellitic acid dianhydride 4.83 g (22.1 mmol) was poured in several times and stirred under a nitrogen atmosphere at room temperature for 1 hour. Next, 4,4′-diaminodiphenyl ether 25.38 g (126.7 mmol) was added and stirred for 30 minutes, then 3,3′,4,4′-biphenyl tetracarboxylic acid dianhydride 2.19 g (7.5 mmol) was poured in several times. After stirring for 30 minutes, pyromellitic acid dianhydride 25.10 g (115.1 mmol) was added several times. After stirring for 1 hour, 13.25 of an N,N′-dimethylacetamide solution (6% by weight) of pyromellitic acid dianhydride was added dropwise over 30 minutes and stirred for 1 hour.

The polyamic acid thus obtained at 200.00 g was put into a 300-ml separatory flask provided with a DC stirrer and cooled at −10° C. for 1 hour. Next, μ-picoline [at] 24.0 g and acetic anhydride 26.0 g were added and stirred under vacuum for 30 minutes. A part of this polyamic acid mixture was placed on a glass plate and formed into a uniform film using an applicator. It was heated at 90° C. for 15 minute, and the resulting film was separated from the glass sheet. It was drawn at a 1.2 magnification both in the length and width directions by a manual biaxial drawing machine and fixed [set] in a mold. It was heated at 200° C. for 30 minutes, 300° C. for 30 minutes, and 350° C. for 5 minutes to obtain a polyimide film.

For the polyimide film, Young's modulus, linear expansion coefficient, water absorption rate and glass transition temperature were measured; the results are shown in Table 1.

### Application Example 2

Paraphenylenediamine 3.27 g (30.2 mmol) and N,N′-dimethylacetamide 223.58 g were put into a 500-ml separatory flask provided with a DC stirrer, then pyromellitic acid dianhydride 6.54 g (30.0 mmol) was poured in several times and stirred under a nitrogen atmosphere at room temperature for 1 hour. Next, 4,4′-diaminodiphenyl ether 24.25 g (121.1 mmol) was added and stirred for 30 minutes, then 3,3′,4,4′-biphenyl tetracarboxylic acid dianhydride 1.34 g (4.5 mmol) was poured in several times. After further stirring for 30 minutes, pyromellitic acid dianhydride 24.51 g (112.4 mmol) was added several times. After stirring for 1 hour, 12.68 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1, except that no drawing was carried out.

On the polyimide film, Young's modulus, linear expansion coefficient, water absorption rate and glass transition temperature were measured; the results are shown in Table 1.

### Application Example 3

Paraphenylenediamine 2.73 g (25.2 mmol) and N,N′-dimethylacetamide 223.88 g were put into a 500-ml separatory flask provided with a DC stirrer, then pyromellitic acid dianhydride 5.45 g (25.0 mmol) was poured in several times and stirred under a nitrogen atmosphere at room temperature for 1 hour. Next, 4,4′-diaminodiphenyl ether 24.67 g (129.1 mmol) was added and stirred for 30 minutes. Next, pyromellitic acid dianhydride 22.71 g (104.1 mmol) was poured in several times and stirred for 30 minutes, then 3,3′,4,4′-biphenyl tetracarboxylic acid dianhydride 4.37 g (14.8 mmol) was poured in several times. After stirring for 1 hour, 14.06 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

On the polyimide film, Young's modulus, linear expansion coefficient, water absorption rate and glass transition temperature were measured; the results are shown in Table 1.

### Application Example 4

4,4′-Diaminodiphenyl ether 25.15 g (125.6 mmol) and N,N′-dimethylacetamide 224.20 g were put into a 500-ml separatory flask provided with a DC stirrer, then pyromellitic acid dianhydride 27.12 g (14.4 mmol) was poured in several times and stirred under a nitrogen atmosphere at room temperature for 1 hour. Next, paraphenylenediamine 2.40 g (22.2 mmol) was added; after stirring for 30 minutes pyromellitic acid dianhydride 0.92 g (4.2 mmol) was poured in several times and stirred for 30 minutes. Next, 3,3′,4,4′-biphenyl tetracarboxylic acid dianhydride 4.35 g (14.8 mmol) was poured in several times. After stirring for 1 hour, 13.56 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1.

### Application Example 5

4,4′-Diaminodiphenyl ether 24.75 g (123.7 mmol) and N,N′-dimethylacetamide 223.85 g were put into a 500-ml separatory flask provided with a DC stirrer, then pyromellitic acid dianhydride 26.76 g (122.4 mmol) was poured in several times and stirred under a nitrogen atmosphere at room temperature for 1 hour. Next, paraphenylenediamine 2.74 g (25.3 mmol) was added; after stirring for 30 minutes, 3,3′,4,4′-biphenyl tetracarboxylic acid dianhydride 3.51 g (11.9 mmol) was poured in several times and stirred for 30 minutes. Next, pyromellitic acid dianhydride 2.22 g (10.2 mmol) was poured in several times. After stirring for 1 hour, 12.15 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1.

### Comparative Example 1

4,4′-Diaminodiphenyl ether 29.15 g (145.5 mmol) and N,N′-dimethylacetamide 224.17 g were put into a 500-ml separatory flask provided with a DC stirrer and stirred under a nitrogen atmosphere at room temperature. After stirring further for 30 minutes, pyromellitic acid anhydride 30.80 g (141.2 mmol) was poured in several times. After stirring for 1 hour, 13.89 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1.

### Comparative Example 2

Paraphenylenediamine 4.98 g (46.1 mmol), 4,4′-diaminodiphenyl ether 21.52 g (110.7 mmol), and N,N′-dimethylacetamide 224.25 g were put into a 500-ml separatory flask provided with a DC stirrer and stirred under a nitrogen atmosphere at room temperature. After stirring another 30 minutes, pyromellitic acid dianhydride 32.49 g (148.9 mmol) was poured in several times. After stirring for 1 hour, 12.65 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1.

### Comparative Example 3

Paraphenylenediamine 2.48 g (22.5 mmol), 4,4′-diaminodiphenyl ether 25.48 g (127.4 mmol), and N,N′-dimethylacetamide 223.71 g were put into a 500-ml separatory flask provided with a DC stirrer. 3,3′,4,4′-biphenyltetracarboxylic acid dianhydride 1.32 g (4.5 mmol) and pyromellitic acid anhydride 30.69 g (140.7 mmol) were mixed in a 100-ml beaker and added several times. After stirring for 1 hour, 14.79 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1.

### Comparative Example 4

Paraphenylenediamine 0.79 g (7.3 mmol) and N,N′-dimethylacetamide 224.14 g were put into a 500-ml separatory flask provided with a DC stirrer, then pyromellitic acid dianhydride 1.57 g (7.2 mmol) was poured in several times into it and stirred under a nitrogen atmosphere at room temperature for 1 hour. Next, 4,4′-diaminodiphenyl ether 27.74 g (128.5 mmol) was put into it and stirred for 30 minutes, then 3,3′,4,4′-biphenyl tetracarboxylic acid dianhydride 2.15 g (7.3 mmol) was poured in several times. After further stirring for 30 minutes, pyromellitic acid dianhydride 27.69 g (127.0 mmol) was poured in several times. After stirring for 1 hour, 12.96 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1.

### Comparative Example 5

Paraphenylenediamine 5.00 g (46.3 mmol) and N,N′-dimethylacetamide 223.29 g were put into a 500-ml separatory flask provided with a DC stirrer, then pyromellitic acid dianhydride 10.00 g (45.9 mmol) was poured in several times and stirred under a nitrogen atmosphere at room temperature for 1 hour. Next, 4,4′-diaminodiphenyl ether 21.64 g (108.1 mmol) was put into it and stirred for 30 minutes, then 3,3′,4,4′-biphenyl tetracarboxylic acid dianhydride 2.27 g (7.7 mmol) was poured in several times. After further stirring for 30 minutes, pyromellitic acid dianhydride 20.98 g (96.16 mmol) was poured in several times. After stirring for 1 hour, 13.83 g of an N,N′-dimethylacetamide solution (6% by weight) of pyromellitic acid dianhydride was dropped over 30 minutes into it and stirred for 1 hour.

A polyimide film was obtained from the polyamic solution thus obtained in the same manner as in Application Example 1.

For the polyimide film, Young's modulus, linear expansion coefficient, water absorption rate and glass transition temperature were measured; the results are shown in Table 1. Further, since the polyimide film had a glass transition temperature of less than 350° C., it was thermally deformed during heat treatment at 350° C. for 5 minutes and was undulated.

As is seen from the results of Table 1, polyimide films (Application Examples 1˜5) containing polyamic acid formed by block-copolymerizing an aromatic diamine component consisting of 10˜25 mol % of paraphenylenediamine and 75˜90 mol % of 4,4′-diaminodiphenyl ether and an aromatic tetracarboxylic acid component consisting of 75˜99.9 mol % of pyromellitic acid dianhydride and 0.1˜25 mol % of 3,3′,4,4′-biphenyl tetracarboxylic acid dianhydride of the present invention are notably improved with respect to the quality with a Young's modulus of 4 GPa to 5 GPa and linear coefficient 12 ppm/° C. to 20 ppm/° C. as compared with polyimide films obtained by the homopolymerization of 4,4′-diaminodiphenyl ether and pyromellitic acid dianhydride in Comparative Example 1.

Further, as is clear from the results of Table 1, polyimide films (Application Examples 1˜5) consisting of polyamic acid formed by block-copolymerizing an aromatic diamine component consisting of 10˜25 mol % of paraphenylenediamine and 75˜90 mol % of 4,4′-diaminodiphenyl ether and an aromatic tetracarboxylic acid component consisting of 75˜99.9 mol % of pyromellitic acid dianhydride and 0.1˜25 mol % of 3,3′,4,4′-biphenyl tetracarboxylic acid dianhydride of the present invention are notably improved with respect to the quality with a water absorption rate of 2.6% by weight or less as compared with a polyimide film obtained by the random copolymerization of 4,4′-diaminodiphenyl ether consisting of 25 mol % of paraphenylenediamine and 75 mol % of 4,4′-diaminodiphenyl ether and pyromellitic acid dianhydride in Comparative Example 2.

Furthermore, as is clear from the results of Table 1, polyimide films (Application Examples 1˜5) consisting of polyamic acid formed by block-copolymerizing an aromatic diamine component consisting of 10˜25 mol % of paraphenylenediamine and 75˜90 mol % of 4,4′-diaminodiphenyl ether and an aromatic tetracarboxylic acid component consisting of 75˜99.9 mol % of pyromellitic acid dianhydride and 0.1˜25 mol % of 3,3′,4,4′-biphenyl tetracarboxylic acid dianhydride of the present invention are notably improved with respect to the quality with a Young's modulus of 4 GPa to 5 GPa and linear expansion coefficient of 12 ppm/° C. to 20 ppm/° C. as compared with a polyimide film obtained by the random copolymerization of 15 mol % of paraphenylenediamine, 85 mol % of 4,4′-diaminophenyl ether, 97 mol % of pyromellitic acid dianhydride and 3 mol % of 3,3′,4,4′-biphenyl tetracarboxylic acid dianhydride in Comparative Example 3.

Furthermore, as is clear from the results of Table 1, polyimide films (Application Examples 1˜5) consisting of polyamic acid formed by block-copolymerizing an aromatic diamine component consisting of 10˜25 mol % of paraphenylenediamine and 75˜90 mol % of 4,4′-diaminodiphenyl ether and an aromatic tetracarboxylic acid component consisting of 75˜99.9 mol % of pyromellitic acid dianhydride and 0.1˜25 mol % of 3,3′,4,4′-biphenyl tetracarboxylic acid dianhydride of the present invention are notably improved with respect to the quality with a Young's modulus of 4 GPa to 5 GPa and linear expansion coefficient of 12 ppm/° C. to 20 ppm/° C. as compared with a polyimide film obtained by the block-copolymerization of 15 mol % of paraphenylenediamine, 85 mol % of 4,4′-diaminophenyl ether, 97 mol % of pyromellitic acid dianhydride and 3 mol % of 3,3′,4,4′-biphenyl tetracarboxylic acid dianhydride in Comparative Example 4.

Furthermore, as is clear from the results of Table 1, polyimide films (Application Examples 1˜5) consisting of polyamic acid formed by block-copolymerizing an aromatic diamine component consisting of 10˜25 mol % of paraphenylenediamine and 75˜90 mol % of 4,4′-diaminodiphenyl ether and an aromatic tetracarboxylic acid component consisting of 75˜99.9 mol % of pyromellitic acid dianhydride and 0.1˜25 mol % of 3,3′,4,4′-biphenyl tetracarboxylic acid dianhydride of the present invention are notably improved with respect to the quality with a Young's modulus of 4 GPa to 5 GPa, linear expansion coefficient of 12 ppm/° C. to 20 ppm/° C. and glass transition temperature of 350° C. or higher as compared with a polyimide film obtained by the block-copolymerization of 30 mol % of paraphenylenediamine, 70 mol % of 4,4′-diaminodiphenyl ether, 95 mol % of pyromellitic acid dianhydride and 5 mol % of 3,3′,4,4′-biphenyl tetracarboxylic acid dianhydride in Comparative Example 5.

Young's modulus as used herein is intended to be determined from the slope of the initial rising section in a tension-strain curve obtained at room temperature with a tensile velocity of 300 mm/min, using a Tensilon brand (or similar type) tensile tester manufactured by the Orientec Co., Ltd., in accordance with JIS K7113.

Linear expansion coefficient as used herein is intended to be measured in the temperature range of from 50° C. to 200° C. under a rate of temperature increase of 10° C./min by TMA-50 brand (or similar type) instrument, manufactured by the Shimadzu Co., Ltd.

Water absorption rate as used herein is intended to be determined by the loss in weight in the temperature range of 50˜200° C. by weight loss analysis under heating when the polyimide film is immersed in distilled water for 48 hours and is heated from room temperature to 200° C. at a rate of temperature increase of 10° C./min after the water on the surface is wiped off.

Glass transition temperature as used herein is intended to be determined from the peak of the elastic modulus loss measured under conditions of a temperature range of room temperature to 500° C., rate of temperature increase of 2° C./min, and frequency of 10 Hz by EXSTER 6000, manufactured by the Seiko Instrument Co., Ltd.

As explained thus far, according to the present invention, polyimide films can be obtained, which have a Young's modulus of 4 GPa to 5 GPa, thereby superior in handleability and flexibility, linear expansion coefficient of 12 ppm/° C. to 20 ppm/° C. and water absorption rate of 2.6% by weight or less, thereby superior in dimensional stability; and glass transition temperature of 350° C. or higher, thereby superior in heat resistance, and these polyimide films can be effectively utilized as base films for flexible circuit boards.

Further, according to the present invention, high-quality polyimide films can be mass-produced efficiently at low cost without requiring many reagents, time, labor, and the like in the treatments for enhancing the Young's modulus, linear expansion coefficient, water absorption rate and glass transition temperature of the polyimide films, so their usage in this field is high

What is claimed is:

1. A polyimide film comprising a block copolymer, the block copolymer comprising:
A. an aromatic diamine component derived from:
i. 10-25 mol % paraphenylenediamine;
ii. 75-90 mol % 4,4′-diaminodiphenyl ether; and
B. an aromatic tetracarboxylic acid component derived from:
i. 75-99.9 mol % pyromellitic acid dianhydride; and
ii. 0.1-25 mol % of 3,3′,4,4′-biphenyl tetracarboxylic acid dianhydride.

2. A polyimide film in accordance with claim 1, having a Young's modulus in a range from 4 GPa to 5 GPa.

3. A polyimide film in accordance with claim 2, having a linear expansion coefficient in a range of 12 ppm/° C. to 20 ppm/° C.

4. A polyimide film in accordance with claim 3, having a water absorption rate of 2.6 wt % or less.

5. A polyimide film in accordance with claim 4, having a glass transition temperature of 350° C. or higher.

6. A method of manufacturing a polyimide film comprising:
a. creating a polyamic acid by:
i. combining paraphenylenediamine with pyromellitic acid dianhydride, the paraphenylenediamine being in molar excess relative to the pyromellitic acid dianhydride; and
ii. then adding 4,4′-diaminodiphenyl ether;
iii. then adding 3,3′,4,4′-biphenyl tetracarboxylic acid dianhydride; and
iv. then adding additional pyromellitic acid anhydride;
b. then block-copolymerizing the polyamic acid and concurrently or subsequently forming the block-copolymerized polyamic acid into a film; and
c. imidizing the polyamic acid film by thermal curing, chemical curing or a combination of thermal and chemical curing.

7. A method of manufacturing a polyimide film comprising:
a. creating a polyamic acid by:
i. combining paraphenylenediamine with pyromellitic acid dianhydride, the paraphenylenediamine being in molar excess relative to the pyromellitic acid dianhydride; and
ii. then adding 4,4′-diaminodiphenyl ether;
iii. then adding additional pyromellitic acid anhydride; and
iv. then adding 3,3′,4,4′-biphenyl tetracarboxylic acid dianhydride;
b. then block-copolymerizing the polyamic acid and concurrently or subsequently forming the block-copolymerized polyamic acid into a film; and
c. imidizing the polyamic acid film by thermal curing, chemical curing or a combination of thermal and chemical curing.

8. A method of manufacturing a polyimide film comprising:
a. creating a polyamic acid by:
i. combining 4,4′-diaminodiphenyl ether with pyromellitic acid dianhydride, the 4,4′-diaminodiphenyl ether being in molar excess relative to the pyromellitic acid dianhydride; and
ii. then adding paraphenylenediamine;
iii. then adding additional pyromellitic acid anhydride; and
iv. then adding 3,3′,4,4′-biphenyl tetracarboxylic acid dianhydride;
b. then block-copolymerizing the polyamic acid and concurrently or subsequently forming the block-copolymerized polyamic acid into a film; and
c. imidizing the polyamic acid film by thermal curing, chemical curing or a combination of thermal and chemical curing.

9. A method of manufacturing a polyimide film comprising:
a. creating a polyamic acid by:
i. combining 4,4′-diaminodiphenyl ether with pyromellitic acid dianhydride, the 4,4′-diaminodiphenyl ether being in molar excess relative to the pyromellitic acid dianhydride; and
ii. then adding paraphenylenediamine;
iii. then adding additional pyromellitic acid anhydride; and
iv. then adding 3,3′,4,4′-biphenyl tetracarboxylic acid dianhydride;
b. then block-copolymerizing the polyamic acid and concurrently or subsequently forming the block-copolymerized polyamic acid into a film; and
c. imidizing the polyamic acid film by thermal curing, chemical curing or a combination of thermal and chemical curing.
